(19) United States
(12) Patent Application Publication
(10) Pub. No.: US 2024/0109084 A1
(43) Pub. Date: Apr. 4, 2024

(54) STRIP IRRIGATION SPRINKLER

(71) Applicant: NETAFIM, LTD., TEL AVIV (IL)

(72) Inventor: IDO BEN HERZEL, MOSHAV OLESH (IL)

(73) Assignee: NETAFIM, LTD., TEL AVIV (IL)

(21) Appl. No.: 18/540,993

(22) Filed: Dec. 15, 2023

Related U.S. Application Data
(63) Continuation-in-part of application No. PCT/IB2022/055522, filed on Jun. 15, 2022.
(60) Provisional application No. 63/211,167, filed on Jun. 16, 2021.

(51) Int. Cl. B05B 3/04; A01G 25/00

(52) U.S. Cl. CPC B05B 3/0486; A01G 25/00

(57) ABSTRACT

A strip irrigator sprinkler has a central axis X and includes a stationary body and a diffuser coupled to the stationary body. The diffuser can rotate about the central axis X relative to the stationary body and the sprinkler includes in addition at least one outlet opening out of the stationary body that is arranged to emit liquid towards the diffuser along an axis Y that extends generally alongside axis X at a given lateral side of axis X.

### RELATED APPLICATIONS

This is a Bypass Continuation-in-Part of International Patent Application No. PCT/IB2022/055522, filed Jun. 15, 2022, and published as WO 2022/265044A1. Priority is claimed to U.S. Provisional Patent Application No. 63/211,167, filed Jun. 16, 2021. The contents of the above-identified applications are incorporated by reference in their entirety.

### TECHNICAL FIELD

Embodiments of the invention relate to a sprinkler and in particular to a strip irrigator sprinkler.

### BACKGROUND

Strip irrigators are arranged to irrigate in a generally rectangular narrow pattern. This may be useful in irrigating a targeted area for example along a line of crops, while avoiding wasteful irrigation at locations that are not of interest. Such precise irrigation patterns may find use in various applications, such as in protection against frost, providing permanent spray systems, heat protection/cooling (and the like).

U.S. Pat. No. 6,076,746 describes a strip irrigator with a distribution member that is arranged such that responsive to a water jet emitted against it, generates reactionary forces imparting it to act in a reciprocal rocking motion that assists in a formation of a rectangular narrow irrigation pattern.

### SUMMARY

The following embodiments and aspects thereof are described and illustrated in conjunction with systems, tools and methods which are meant to be exemplary and illustrative, not limiting in scope.

In an embodiment there is provided a strip irrigator sprinkler having a central axis X and comprising a stationary body and a diffuser coupled to the stationary body and arranged to rotate about the central axis X relative to the stationary body, the sprinkler comprising in addition at least one outlet opening out of the stationary body that is arranged to emit liquid towards the diffuser along an axis Y that extends generally alongside axis X at a given lateral side of axis X.

Said given lateral side of axis X can be seen as defining a respective given lateral direction along which liquid emitted along said axis Y at the defined given lateral side of axis X—can be deflected sideways away from axis X.

Preferably, interaction between emitted liquid from the at least one outlet and the revolving diffuser is arranged to form a generally rectangular strip of irrigation extending in the direction of the given lateral side. The term rectangular in the sense of the irrigation pattern formed by the presently disclosed strip irrigator should be taken in its broadest sense to define a shape bound also by curves, such as a shape at least in part resembling an ellipse (or the like) when viewed from above along axis X of the strip irrigator.

In addition to the exemplary aspects and embodiments described above, further aspects and embodiments will become apparent by reference to the figures and by study of the following detailed descriptions.

### BRIEF DESCRIPTION OF THE FIGURES

Exemplary embodiments are illustrated in referenced figures. It is intended that the embodiments and figures disclosed herein are to be considered illustrative, rather than restrictive. The invention, however, both as to organization and method of operation, together with objects, features, and advantages thereof, may best be understood by reference to the following detailed description when read with the accompanying figures, in which:

FIG. 1 schematically shows a group of sprinklers in accordance with an embodiment of the present invention, which irrigate each in a rectangular narrow pattern, with an enlarged section illustrating one of the sprinklers;

FIG. 2 schematically shows a closer view of an embodiment of a sprinkler of the present invention;

FIG. 3 schematically shows an exploded view of the sprinkler of FIG. 2;

FIGS. 4A to 4C schematically show exploded views of sprinkler embodiments of the present invention and their respective rectangular sprinkling patterns;

FIG. 5A shows a lower view of an embodiment of a sprinkler's diffuser.

FIGS. 5B, 5C, 5D and 5E each show sprinkling sub-patterns created by different sectors of the diffuser.

FIG. 5F shows the rectangular sprinkling pattern created by the superposition of the springling sub-patters of FIGS. 5B-5E that can be formed according to said sprinkler embodiment.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

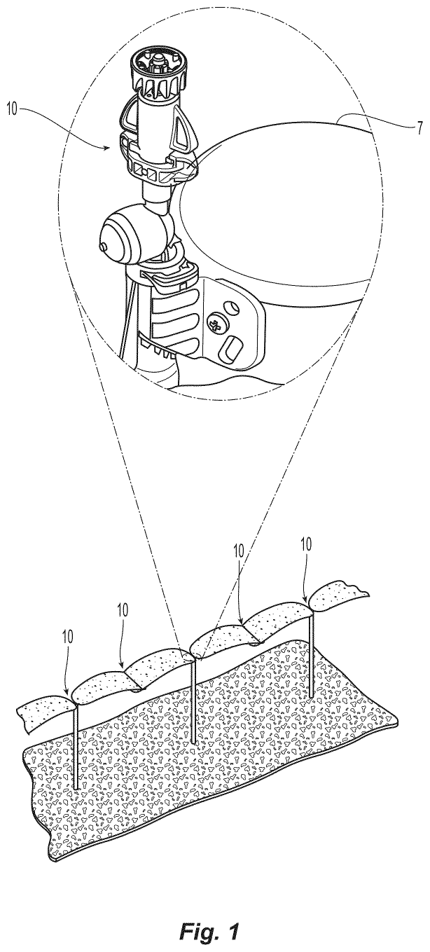

Attention is first drawn to FIG. 1 illustrating a group of sprinklers 10 in accordance with an embodiment of the present invention. Each one of the sprinklers is a strip irrigator sprinkler suitable for irrigating in a generally narrow rectangular pattern. The enlarged section at the upper side of the figure provides a closer view of one of the sprinklers in this example being supported by a pole 7 in a field at a position above a ground face of the field.

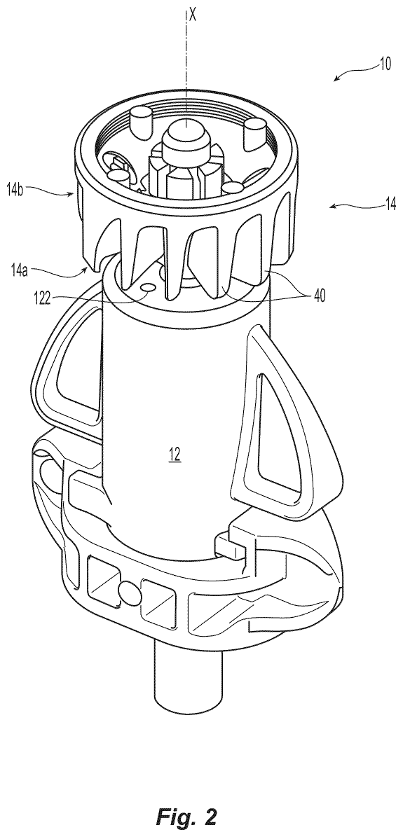

Attention is drawn to FIG. 2 illustrating an embodiment of a sprinkler 10 of the present invention. Sprinkler 10 as seen includes a lower stationary body 12 and an upper diffuser 14 that is arranged to rotate about a central axis X of the sprinkler.

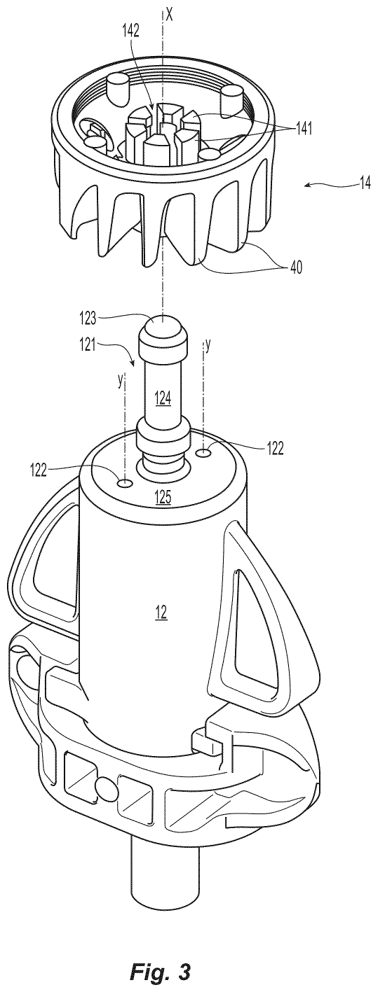

Attention is drawn to FIG. 3 showing an exploded view of the sprinkler seen in FIG. 2. As seen, stationary body 12 includes a stem 121 that projects generally perpendicularly upwards along the sprinkler's axis X from a shelf 125 of the body. In addition, stationary body 12 includes two emitting outlets 122 that open out at the shelf 125 and are arranged each to emit a liquid stream along a respective axis Y that is generally parallel and alongside axis X.

Stem 121 may be formed at its upper end with an enlarged head 123 that widens laterally sideways (away from axis X) to from a cap like formation above a narrower lower portion 124 of the stem. Diffuser 14 may be arranged to include an opening 142 that extends axially therethrough for receiving the stem 121 of the stationary body. Several snap members 141 may be formed about axis X and opening 142 at an upper side of the diffuser.

Attachment of diffuser 14 to stem 121 may be accomplished by placing the stem with its head 123 leading through the opening 142 of the diffuser, while the snap members 141 of the diffuser snap over the stem's head as it passes through the opening 142 and remain affixed to the stem at its narrower lower portion 124. In this assembled state, the diffuser can be rotatably coupled to the sprinkler's′ stationary body at its stem 121.

Pressurized liquid entering sprinkler 10 at a lower side of its stationary body 12, may be arranged to exit the stationary body via the outlets 122 in this example as two liquid streams to impinge against a lower side of diffuser 14.

The impinging liquid streams are arranged to urge the diffuser to rotate while being deflected sideways to form, in the example seen in FIG. 1, two generally rectangular segments of sprayed liquid that extend in opposing lateral direction away from axis X.

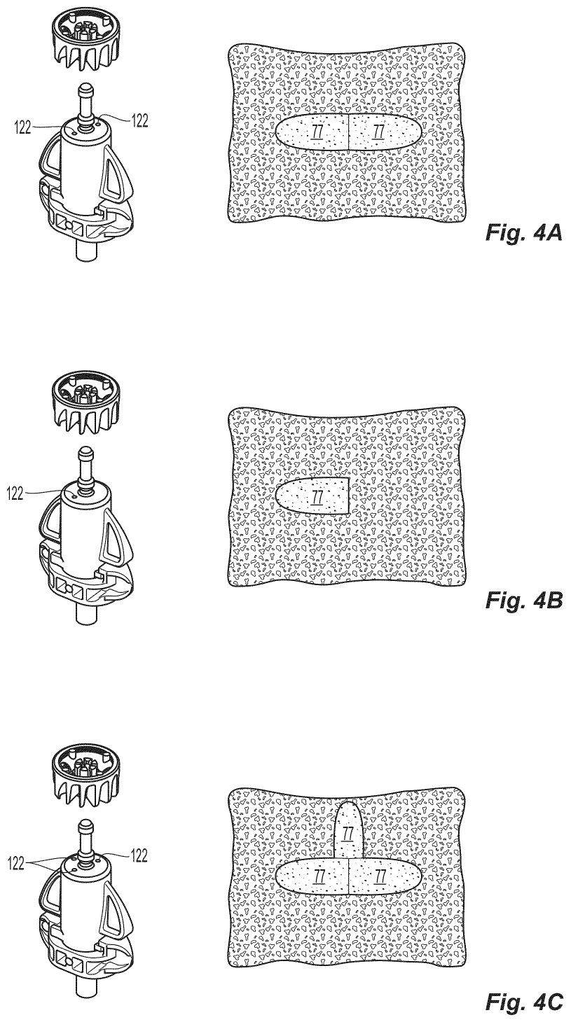

Attention is drawn to FIGS. 4A to 4C illustrating various sprinkler embodiments, each differing from the other, inter alia, in the number of outlets 122 and in the respective generally rectangular sprinkling patterns that can be provided.

The sprinkler seen in FIG. 4A includes two outlets 122 that produce each a rectangular narrow pattern 77 that extends laterally away from the sprinkler's central axis. In the example of FIG. 4A, the outlets 122 are displaced by about 180 degrees one from the other about axis X and so are the resulting rectangular patterns 77 that are formed.

The sprinkler seen in FIG. 4B includes only one outlet 122 that produces one single generally rectangular narrow pattern 77 that extends laterally away from the sprinkler's central axis.

The sprinkler seen in FIG. 4C includes three outlets 122 that produce each a rectangular narrow pattern 77 that extends laterally away from the sprinkler's central axis. In the example of FIG. 4C, the outlets 122 are displaced by about 90 degrees one from the other about axis X and so are the resulting generally rectangular patterns 77 that are formed.

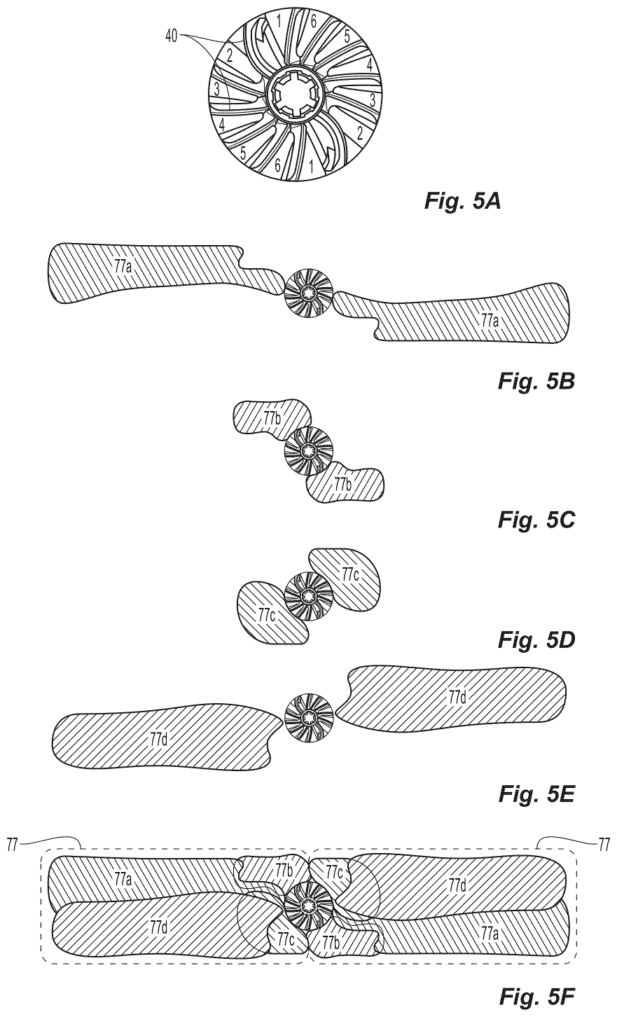

Attention is drawn to FIG. 5A illustrating a view of an embodiment of a sprinkler's diffuser 14 from below. As seen, the diffuser 14 is formed at its lower side with two identical sets of flow channels tagged ‘ l’ to ‘6’. The flow channels open out to a lower side 14a of the diffuser 14 which faces the stationary body, and also open out to the peripheral side 14b of the diffuser 14. The flow channels 1— 6 may differ from one another in one or more of angular extent (both on the lower side and the peripheral side), size and shape. The flow channels are separated from one another by circumferentially spaced apart vanes 40—in other words, the vanes 40 at least partially define the flow channels. It is understood that each flow channel is defined by mutually facing surfaces of circumferentially adjacent vanes 40. The vanes 40 themselves may be circumferentially spaced apart from one another by different amounts and thus have uneven angular spacing. The vanes 40 may also differ from one another in one or more of angular thickness, size, shape and orientation (“tilt”). This variation in the angular spacing, size and shape of the vanes results in the differently configured flow channels and thus in the various spraying sub-patterns seen in FIGS. 5B-5E, discussed below.

Liquid emitted from an outlet 122 of the sprinkler is adapted to impinge against the lower side of the diffuser 14 and urge it to revolve in direction R about the sprinkler's central axis X. More particularly, the emitted liquid may travel along a direct path from outlet(s) 122 to impinge on the vanes 40 of the diffuser 14, thereby directly rotating the latter. This contrasts from arrangements in which the emitted liquid indirectly rotates the diffuser by means of an intervening rotatable element which is rotated by the liquid first, and by virtue of being coupled to the diffuser, then indirectly rotates the latter. As such, the presently disclosed sprinkler is devoid of a separate intervening element which is coupled to the diffuser, is directly rotated by liquid emitter by the outlets, and then by virtue of the coupling, rotates the diffuser.

Attention is drawn to FIGS. 5B-5E illustrating sub-patterns that may be formed in response to interaction between emitted liquid from the sprinkler's outlet(s) 122 and respective flow channels within the revolving diffuser. In this example, superimposing the sub-patterns one over the other can form the resulting generally rectangular pattern(s) 77 (see FIG. 5F) of the sprinkler.

The sub-patterns 77b (FIG. 5C) may be formed as emitted liquid engages a certain flow channel, e.g., flow channels 1. The sub-patterns 77c (FIG. 5D) may be formed as emitted liquid engages a certain other flow channel, e.g., flow channels 2. The sub-patterns 77a (FIG. 5B) may be formed as emitted liquid engages yet other flow channels, e.g., flow channels 3 and 4. And the sub-patterns 77d (FIG. 5E) may be formed as emitted liquid engages even yet other flow channels, e.g., flow channels 5 and 6.

As seen in this example, the area size of the sub-patterns may differ, with here the generally similar sized sub-patterns 77b and 77c being smaller than the generally similar sized sub-patterns 77a and 77d. Thus, as seen in FIG. 5F, the plurality of flow channels may each create different, overlapping sprinkling sub-patterns, and the collection of these overlapping sprinkling sub-patterns may collectively create a substantially rectangular sprinkling pattern, using a single sprinkler of the present invention.

In Cases where the Emitted Liquid Via Each Flow Channel May be Generally Similar, if Each One of the Differently Sized Sub-Patterns would Receive Liquid from a Single Flow Channel—the Distribution of Liquid Over an Entire Rectangular Pattern 77 May be Non-Even,

To mitigate this, in this example larger cross-sectional areas within the diffuser are dedicated for the formation of the larger sized sub-patterns. Here, the dedication of the larger cross-sectional areas within the diffuser for the formation of sub-patterns 77a and 77d is exemplified by using two flow channels for the formation of each one of these sub-patterns (i.e., flow channels 3 and 4 for sub-pattern 77a and flow channels 5 and 6 for sub-pattern 77d).

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

Furthermore, while the present application or technology has been illustrated and described in detail in the drawings and foregoing description, such illustration and description are to be considered illustrative or exemplary and non-restrictive; the technology is thus not limited to the disclosed embodiments. Variations to the disclosed embodiments can be understood and effected by those skilled in the art and practicing the claimed technology, from a study of the drawings, the technology, and the appended claims.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage.

The present technology is also understood to encompass the exact terms, features, numerical values or ranges etc., if in here such terms, features, numerical values or ranges etc. are referred to in connection with terms such as “about, ca., substantially, generally, at least” etc. In other words, “about 3” shall also comprise “3” or “substantially perpendicular” shall also comprise “perpendicular”. Any reference signs in the claims should not be considered as limiting the scope.

Although the present embodiments have been described to a certain degree of particularity, it should be understood that various alterations and modifications could be made without departing from the scope of the invention as hereinafter claimed.

What is claimed is:

1. A strip irrigator sprinkler having a central axis (X) and comprising:
a stationary body having at least one outlet arranged to emit liquid along an axis (Y) that extends generally alongside the central axis (X) at a given lateral side of said central axis (X); and
a diffuser mounted on the stationary body and arranged to rotate about the central axis (X) relative to the stationary body, the diffuser comprising a plurality of circumferentially spaced apart flow channels, the flow channels opening out to both a lower side of diffuser facing the stationary body, and also to a peripheral side of the diffuser; such that:
liquid emitted from the at least one outlet is arranged to directly impinge against the diffuser, thereby urging the diffuser to rotate.

2. The strip irrigator sprinkler of claim 1, wherein:
the diffuser, at its lower side, further comprises a plurality of circumferentially spaced apart vanes which define the flow channels; and
liquid emitted from the at least one outlet directly impinges on said vanes and is deflected sideways away from the central axis (X), in a radially outward direction.

3. The strip irrigator sprinkler of claim 2, wherein:
each of said flow channels is defined between mutually facing surfaces of circumferentially adjacent vanes;
at least some flow channels differ from one another in one or more of angular extent, size and shape; and
at least some vanes have unequal circumferential angular spacing and at least some vanes differ from one another in one or more of angular thickness, size, shape and orientation.

4. The strip irrigator sprinkler of claim 3, wherein:
a spray sub-pattern is formed by liquid exiting each of the flow channels via the diffuser's peripheral side;
the spray sub-patterns formed by at least two different flow channels differ from one another in at least one of area size, shape and angular orientation relative to the central axis (X); and
superimposing the spray sub-pattens forms a rectangular strip-like spray pattern.

5. The strip irrigator sprinkler of claim 1, wherein liquid emitted towards the diffuser and engaging the diffuser is deflected sideways away from the central axis (X) in a lateral direction of the given lateral side.

6. The strip irrigator sprinkler of claim 5, wherein interaction between emitted liquid from the at least one outlet and the rotating diffuser forms a rectangular strip-like spray pattern of irrigation extending in the direction of the given lateral side.

7. The strip irrigator sprinkler of claim 6, wherein the rectangular strip-like spray pattern is formed by interaction of the emitted liquid with a group of the flow channels.

8. The strip irrigator sprinkler of claim 7, wherein interaction of emitted liquid with each flow channel of the group forms a sub-pattern of irrigation and superimposing the sub-patterns of the group one over the other forms the resulting rectangular strip-like spray pattern of irrigation.

9. The strip irrigator sprinkler of claim 8, wherein at least some of the sub-patterns of the group are substantially different in one or more of area size, shape and angular orientation relative to the central axis (X), than other sub-patterns of the group.

10. The strip irrigator sprinkler of claim 9, wherein a given sub-pattern of the group that is substantially larger in area size than a certain other sub-pattern of the group is arranged to receive more liquid than that deflected to form the certain other smaller sub-pattern.

11. The strip irrigator sprinkler of claim 10, wherein deflecting more liquid to form the given sub-pattern is obtained by directing more than one flow channel of the diffuser to deflect liquid to form the given sub-pattern.

12. The strip irrigator sprinkler of claim 1, wherein the at least one outlet is two or more outlets each forming a respective generally rectangular strip of irrigation.

13. The strip irrigator sprinkler of claim 1, wherein coupling the diffuser to the stationary body is by snap fitting the diffuser onto a stem of the stationary body.

14. A strip irrigator sprinkler having a central axis (X) and comprising:
a stationary body having at least one outlet arranged to emit liquid along an axis (Y) that extends generally alongside the central axis (X) at a given lateral side of said central axis (X); and
a diffuser mounted on the stationary body and arranged to rotate about the central axis (X) relative to the stationary body, the diffuser comprising a plurality of circumferentially spaced apart flow channels, the flow channels opening out to both a lower side of diffuser facing the stationary body, and also to a peripheral side of the diffuser; wherein:
liquid emitted from the at least one outlet interacts with each member of a group of said flow channels to form a spray sub-pattern with each said member;
at least some of the spray sub-patterns of the group differ from one another in area size and/or shape; and
superimposing the spray sub-patterns of the group one over the other forms a rectangular strip-like spray pattern of irrigation.

15. The strip irrigator sprinkler of claim 14, wherein a given sub-pattern of the group that is substantially larger in area size than a certain other sub-pattern of the group is arranged to receive more liquid than that deflected to form the certain other smaller sub-pattern.

16. The strip irrigator sprinkler of claim 15, wherein deflecting more liquid to form the given sub-pattern is obtained by directing more than one flow channel of the diffuser to deflect liquid to form the given sub-pattern.

17. The strip irrigator sprinkler of claim 14, wherein the at least one outlet is two or more outlets each forming a respective generally rectangular strip of irrigation.

18. The strip irrigator sprinkler of claim 14, wherein:
the diffuser, at its lower side, further comprises a plurality of circumferentially spaced apart vanes which define the flow channels; and
liquid emitted from the at least one outlet directly impinges on said vanes and is deflected sideways away from the central axis (X), in a radially outward direction.

19. The strip irrigator sprinkler of claim 18, wherein:
each of said flow channels is defined between mutually facing surfaces of circumferentially adjacent vanes;
at least some flow channels differ from one another in one or more of angular extent, size and shape; and
at least some vanes have unequal circumferential angular spacing and at least some vanes differ from one another in one or more of angular thickness, size, shape and orientation.

20. A strip irrigator sprinkler having a central axis (X) and comprising a stationary body and a diffuser coupled to the stationary body and arranged to rotate about the central axis (X) relative to the stationary body,
the sprinkler further comprising at least one outlet opening out of the stationary body and arranged to emit liquid to interact with a group of flow channels formed in the diffuser, the liquid being emitted along an axis (Y) that extends generally alongside the central axis (X) at a given lateral side of the central axis (X), wherein:
liquid emitted from the at least one outlet interacts with each member of the group of said flow channels to form a spray sub-pattern with each said member;
at least some of the spray sub-patterns of the group differ from one another in area size and/or shape; and
superimposing the spray sub-patterns of the group one over the other forms a rectangular strip-like spray pattern of irrigation.

21. The strip irrigator sprinkler of claim 20, wherein:
the diffuser, at its lower side, further comprises a plurality of circumferentially spaced apart vanes which define the flow channels; and
liquid emitted from the at least one outlet directly impinges on said vanes and is deflected sideways away from the central axis (X), in a radially outward direction.

22. The strip irrigator sprinkler of claim 21, wherein:
each of said flow channels is defined between mutually facing surfaces of circumferentially adjacent vanes;
sub-patterns of the group differ from one another in one or more of area size, shape and angular orientation relative to the central axis (X).
